(19) United States
(12) Patent Application Publication
(10) Pub. No.: US 2015/0120955 A1
(43) Pub. Date: Apr. 30, 2015

(54) Alignment Markers in Multi-Lane Networking

(71) Applicant: Broadcom Corporation, Irvine, CA (US)

(72) Inventor: Zhongfeng Wang, Irvine, CA (US)

(21) Appl. No.: 14/524,385

(22) Filed: Oct. 27, 2014

Related U.S. Application Data
(60) Provisional application No. 61/896,274, filed on Oct. 28, 2013.

(51) Int. Cl. H04L 12/851; H04L 29/06

(52) U.S. Cl. CPC H04L 47/2483; H04L 65/601
USPC 709/231

(57) ABSTRACT

A marker spacing between two consecutive alignment marker (AM) blocks is defined for virtual lanes in a multi-virtual-lane networking protocol. A system using the networking protocol includes circuitry configured to identify virtual and physical lane groupings and numbers based on the AM blocks. The system may use error coding groups to allow for distribution of the AM blocks to the physical lanes in integer numbers of error correction blocks. The identification scheme may be based on sequences derived from a known bit pattern and the bit inverse of the bit pattern. The system may include matching units identify instances of the bit pattern and its bit inverse.

### PRIORITY CLAIM

This application claims priority to provisional application Ser. No. 61/896,274, filed Oct. 28, 2013, which is entirely incorporated by reference.

### TECHNICAL FIELD

This disclosure relates to alignment marker configurations in multi-lane networking protocols.

### BACKGROUND

High speed data networks form part of the backbone of what has become indispensable worldwide data connectivity. Within the data networks, network devices, such as synchronization devices, maintain network timing between interconnected devices and data channels. Improvements in timing maintenance and data channel synchronization will further enhance performance of data networks.

### BRIEF DESCRIPTION OF THE DRAWINGS

FIG. 1 shows an example device.

FIG. 2 shows an example alignment marker (AM) block group.

FIG. 3 shows example marker circuitry.

FIG. 4 shows example logic that transcoding circuitry may implement.

FIG. 5 shows example logic that transcoding circuitry may implement.

FIG. 6 shows an example distribution of AM blocks for 16 virtual lanes and 16 physical lanes divided into 4 groups.

FIG. 7 shows an example distribution of AM blocks for 16 virtual lanes and 8 physical lanes divided into 2 groups.

FIG. 8 shows example AM block groups for 400 Gbps data.

FIG. 9 shows an example partitioned AM block.

FIG. 10 shows an example nibble match unit (NiMU).

FIG. 11 shows an example NiMU.

FIG. 12 shows an example parallel NiMU system.

FIG. 13 shows example logic that alignment circuitry may implement.

### DETAILED DESCRIPTION

The disclosure below concerns techniques and architectures for defining alignment marker (AM) blocks for multi-lane networking protocols. As will be described in more detail below, in some cases, AM blocks may identify a grouping of lanes and the lanes within the group. In some implementations, the techniques and architectures may define the AM blocks to allow for low complexity matching units to identify the AM blocks and parse group and lane designations.

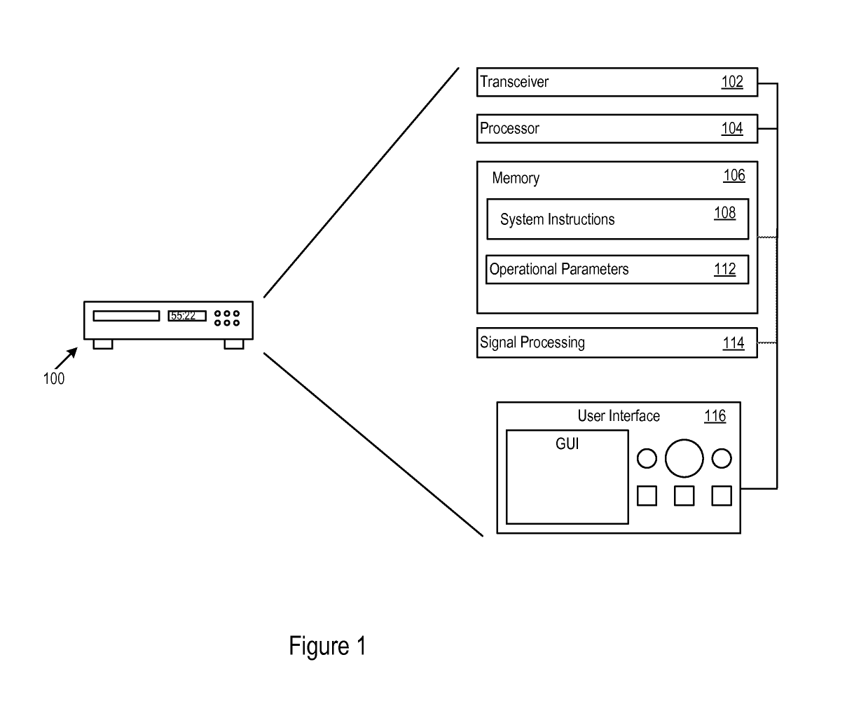

The example device described below provides an example context for explaining the techniques and architectures for defining AM blocks. The techniques and architectures may be implemented in a wide variety of other devices. FIG. 1 shows an example device 100. In one example, the device may be a communication device, such as a rack mount server or personal computer. However, the device may be virtually any device implementing multi-lane network protocols. For example, a cable or satellite set-top box, a console gaming system, laptop, or tablet computer may use such networking protocols. The communication device may include a user interface 116 to allow for user operation of the device.

The device 100 may include transceiver circuitry 102 to support RF and/or optical communication, and one or more processors 104 to support execution of applications and operating systems, and to govern operation of the device. The device 100 may include memory 106 for execution support and storage of system instructions 108 and operational parameters 112. Signal processing circuitry 114 (e.g., an Analog to Digital Converter (ADC), baseband processors or other signal processing circuits.) may also be included to support transmission and reception of networking signals. The signal processing circuitry 114 may further include, define, store, or recognize matching units to identify alignment marker blocks and synchronize physical or logical data lanes. For example, a matching unit (MU) may match nibbles from incoming AM blocks to determine lane groupings and designations.

Multi-lane data networks may implement AM blocks to synchronize data in multiple physical or logic lanes. For example, lanes may include a channel, multiplex of channels, and/or a bandwidth/time allocation using a determined modulation and coding scheme. In various implementations the lanes may be lanes defined for the IEEE 400 Gbps Ethernet standard (IEEE400 GbE). In some cases, AM blocks may contain determined data patterns, e.g., a bit sequence known to the sending and receiving devices. In various implementations, the receiving device may match the incoming AM blocks to the determined data patterns to identify block boundaries and the lane order.

In various implementations, a network protocol or bandwidth allocation within a protocol may use an integer number of lanes. For example, M=K*N lanes may be used, where K is the number of lanes per group and N is the number of groups. For an example IEEE 400 GbE system, 16 physical lanes organized into 4 groups containing 4 lanes per group may be implemented.

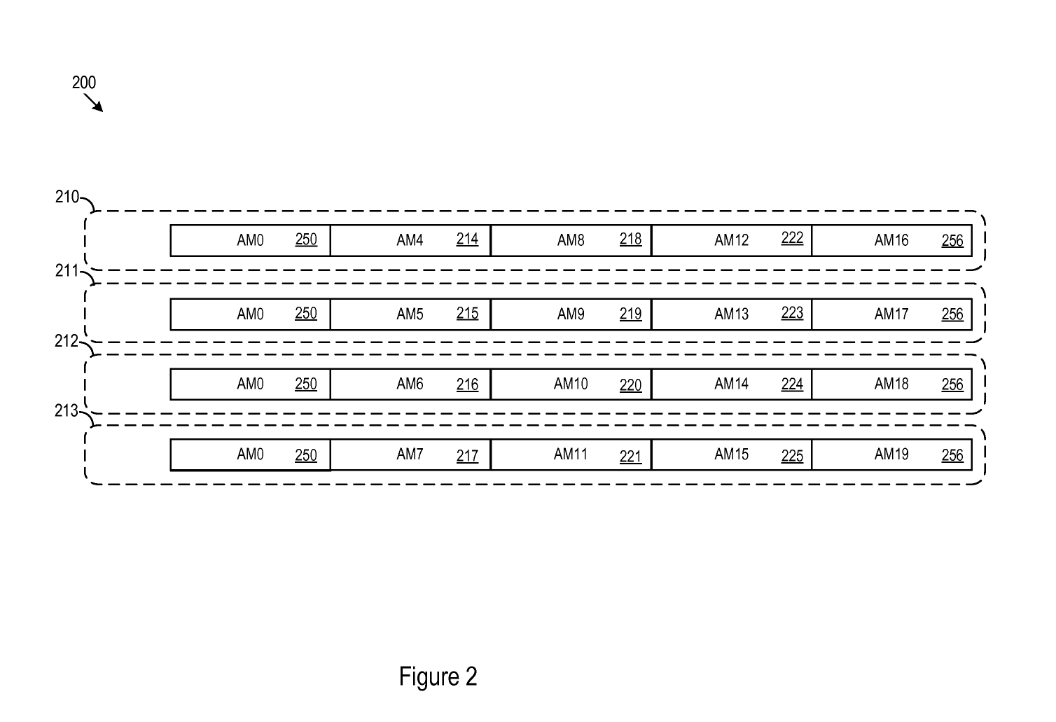

In various implementations, an AM block or group of AM blocks may be sent after a determined number of data blocks are sent. For an example, a 100 Gbps data stream within the example IEEE 400 GbE system may send 4096 blocks of data per AM block group. FIG. 2 shows an example AM block group 200. The group may be sent in a 100 Gbps stream in a lane grouping of 4 virtual lanes 210, 211, 212, 213. The first block 250 in the group for the lanes may be designated AM0. The last block in the group for the lanes 210, 211, 212, 213 may be designated AM16 256. The lanes may have different blocks (e.g., 214, 215, 216, 217, 218, 219, 220, 221, 222, 223, 224, and 225) between the first and the last blocks. In some implementations, an AM block may be 64 bits long.

In some implementations, a lane may be monitored by alignment circuitry for an AM block. For example, in modes other than Energy Efficient Ethernet (EEE) modes a lane may be monitored by alignment logic for an AM0 250 block. In an EEE mode a lane may be monitored for an AM0 250 block and/or an AM16 256 block. If an AM block is found, other blocks 214, 215, 216, 217, 218, 219, 220, 221, 222, 223, 224, 225 sent on the lane 210, 211, 212, 213 may be checked to determine the lane number within the grouping. The AM16 256 block may mark the end of the block group in the lanes 210, 211, 212, 213.

In some implementations, for example an EEE mode, a lane may be monitored for an AM block e.g., an AM0 250 block. The AM16 block may mark the end of the block group in the lanes 210, 211, 212, 213. In some cases, the lane number may be determined by the AM0 block and/or the AM16 block.

In various implementations, data may be transmitted over multiple virtual lanes at the physical coding sub-layer (PCS). In some cases, 16640 66 bit (66b) blocks may be sent between AM blocks. In some implementations, 5 AM blocks may be sent consecutively and may be followed by 5×(16640−1) 66b blocks. However other groupings of AM blocks may be used. In some cases, for example in some 1000 or 40 G systems, AM blocks are separated by (16384−1) 66b data blocks per PCS lane. The greatest common denominator (GCD) of 16640 and 16384 is 256. The size of this GCD may facilitate conversion of 1000 or 40 G data into 400 G data streams. In some cases forward error correction (FEC) may be applied to the data. In some implementations, FEC data may be grouped into blocks with common FEC information. For example, redundantly coded data, such as FEC information, may be applied to error correction within a FEC block. In some implementations FEC blocks may be 5280 bits long, which means 1040 FEC blocks may be included between 2 consecutive AM block groups. In various implementations other numbers of 66b blocks may be used. For example, 16400 66b blocks may be sent between 2 AM block groups. In another example, 16000 66b blocks may be sent between 2 AM block groups. The GCD of 16400 and 16384 is 16, and the GCD of 16000 and 16384 is 128.

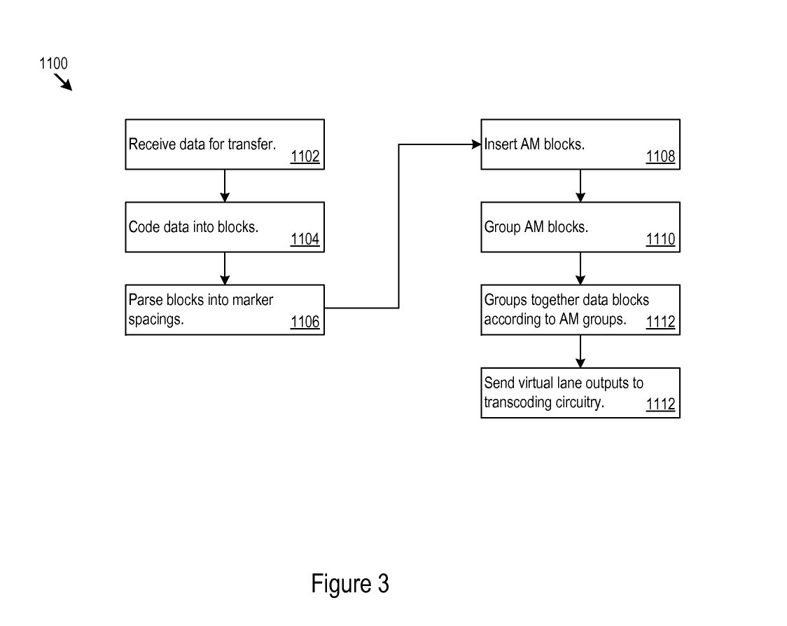

FIG. 3 shows example logic 1100 which may be implemented by marker circuitry. The marker circuitry 1100 may receive data for transfer using virtual lanes (1102). For example, the virtual lanes may include a PCS lane. The marker circuitry 1100 may code the data into blocks (1104). For example, 66b blocks may be used by the marker circuitry 1100. The marker circuitry 1100 may parse the blocks into marker spacings (1106). For example, the blocks may be separated into marker spacings of 16640, 16400, 16000, or other numbers of blocks to be sent with an AM. The marker circuitry may insert AM blocks at the marker spacings (1108). Thus, the number of blocks in the marker spacing may be controlled by the marker circuitry 1100.

In some implementations, the marker circuitry 1100 may group together AMs (1110). Accordingly, the marker circuitry may group together the data blocks to be transferred in groups corresponding to the number of grouped AMs (1112). For example, if 5 AMs are grouped together, 5 marker spacings of blocks may be transferred between the AM groups. An integer multiple of the marker spacing may be placed between groups of AMs based on the number of AMs in the group. Once the AMs have been applied to the virtual lanes, the marker circuitry may send the virtual lane outputs to transcoding circuitry 1000 for transcoding and error correction coding as described below (1114).

In some implementations, the IEEE 400 GbE data may be encoded over 4 1000 data streams using a 100G-KR4 FEC. This may be based on 16 PCS lanes for the IEEE 400 GbE data stream. A FEC block, taking source data from 4 PCS lanes, including its encoded parity data, may be distributed over 4 physical lanes. The associated 4 physical lanes that send the 1000 FEC stream each belong to a particular group.

In various implementations, input data from multiple PCS lanes may be multiplexed to form a new data stream. For example, in an 802.3bj system100G-KR4/CR4/KP4 data may be multiplexed to form a 400 GbE data stream. In some cases, the multiplexing process may use the block size of the data to serve as the granularity for the multiplexing process. For example, a 66b block size may be used. The multiplexed stream may be passed through a transcoding stage followed by FEC encoding. In some cases, Reed-Solomon (RS) FEC may be used.

In various implementations, the multiple virtual lanes may be divided into error correction groups for the transcoding stage. The separation of the error correction groups may allow for independent transcoding operations for the groups. The division of the transcoding operations may allow for block distribution conditions to be met. For example, errors and/or protocol overhead my accrue if the distribution of the data blocks does not meet the integer conditions of the error correction scheme, alignment marker scheme, number of physical lanes in the error correction group, line coding scheme, and/or other protocol conditions. One or more transcoders per group may be used.

In some implementations, 5 consecutive AM blocks may be followed by 5×(16640−1) 66b blocks per PCS lane. Over the 4 PCS lanes, an AM block group may include 20 AM blocks.

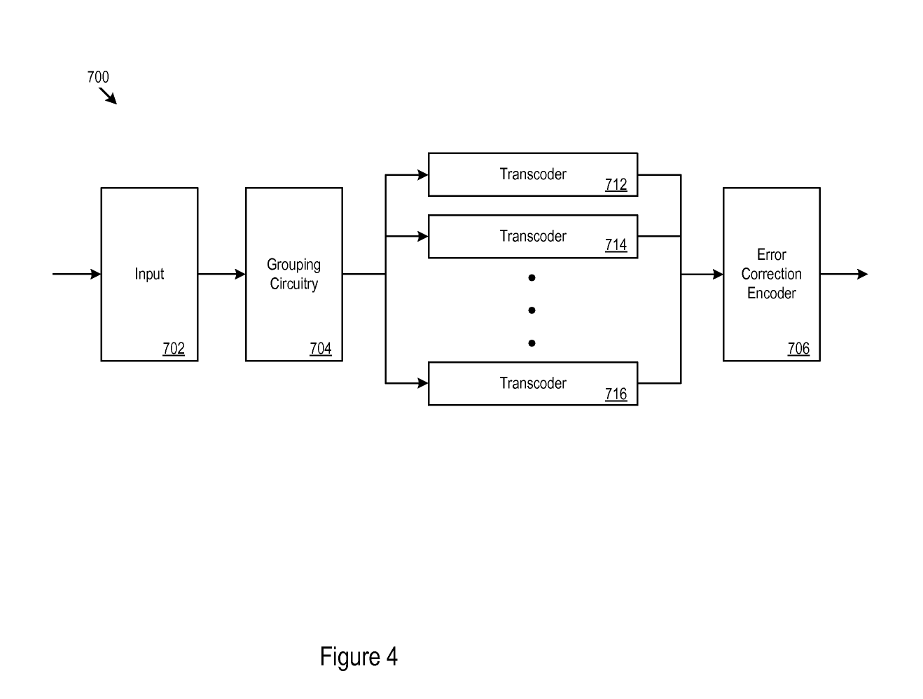

FIG. 4 shows example transcoding circuitry 700. In the example transcoding circuitry, data in virtual lanes may be received at input 702. The virtual lanes may be divided into groups at the grouping circuitry 704. The groups may be passed to the transcoder circuitry for the respective groups 712, 714, 716. The output of the transcoders may be sent to the error correction encoder 706 for coding and distribution to the physical lanes. The error correction groups may be distributed to independent groups of physical lanes.

After transcoding stage, the output from independent transcoders may be multiplexed together at a pre-defined granularity, such as 1 error correction symbol, e.g., 10 bits, to form a uniform input for the error correction encoder. The output of the error correction encoder may be sent to the groups of physical lanes. For example, the symbols may be sent to lanes in a round robin manner, or to groups of lanes in a round robin manner. If the symbols are sent to the groups rather than directly to physical lanes, the symbols may be further distributed within the groups, for example in a round robin manner to the physical lanes within the groups.

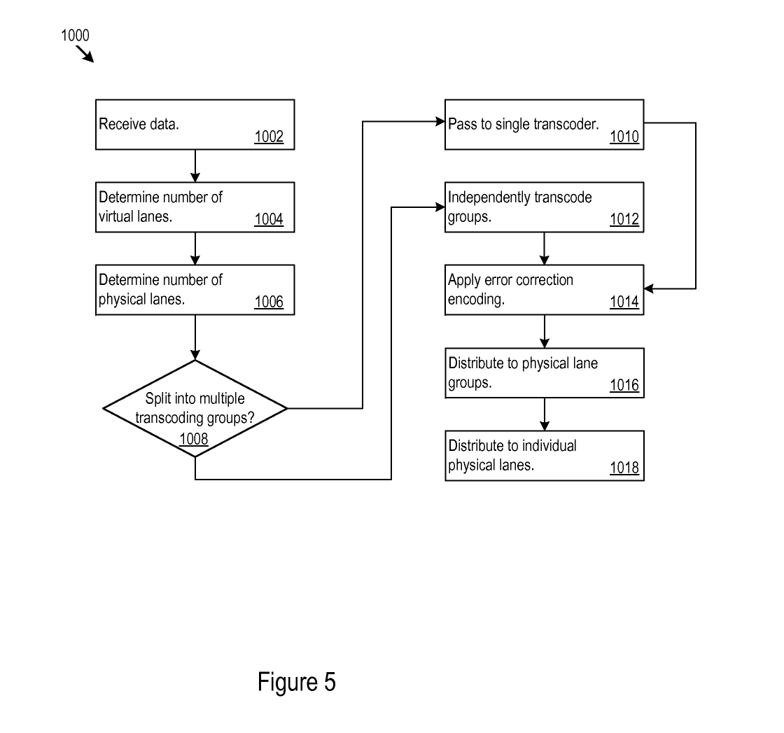

FIG. 5 shows example logic 1000 that transcoding circuitry may implement. An input interface (e.g., 702) may receive data via virtual lane inputs (1002). The transcoding circuitry 1000 may determine the number of virtual lanes (1004). For example, the transcoding circuitry 1000 may determine virtual lane designations by the alignment markers. The transcoding circuitry 1000 may determine the number physical lanes on which to code the virtual lanes (1006). In some cases, the number of physical lanes may be fixed by the setup of the system and/or by the protocol implemented by the transcoding circuitry. The transcoding circuitry may determine whether the virtual lanes and physical lanes may be split into multiple transcoding groups (1008). If the virtual lanes and physical lanes are not split into multiple groups, the received data on the virtual lanes may be passed to a single transcoder for treatment as a single group (1010). If the virtual lanes are split into multiple groups, the various groups of virtual lanes may be sent for independent transcoding (1012). In various implementations, the physical lanes and virtual lanes may be split into the same number of groups. Thus, a given group of virtual lanes may be delivered on a corresponding group of physical lanes. For example, independent transcoding may be achieved by separate and/or parallel transcoding circuitry, time or serially multiplexed transcoding circuitry, and/or other independent transcoding schemes.

Once transcoded, the virtual lane data may be passed by the transcoding circuitry 1000 to error correction circuitry for error correction encoding (1014). For schemes using multiple groups, multiplexed output from the groups may be sent the same error correction circuitry. The error correction circuitry may encode the received transcoded output onto error correction blocks, e.g., 10b error correction blocks.

The transcoding circuitry 1000 may distribute the output of the error correction circuitry to the groups of physical lanes (1016). For example, for a single group of virtual and physical lanes, the data received on the singular group of virtual lanes may be sent to the singular group of physical lanes. In another example, for multiple groups of lanes, data from virtual lane groups may be distributed to corresponding physical lane groups. For example, the output of the error correction circuitry may be setup to send blocks to the groups in a round robin manner. Alternatively or additionally, the output may be setup to distribute the blocks to the physical lanes individually in a round robin manner, where the physical lanes are organized by group. Once the output of the error correction circuitry is distributed to the groups, the transcoding circuitry 1000 may distribute the output to the individual physical lanes (1018). In some cases, the distribution to the individual physical lanes may occur in concert with the distribution to the group of physical lanes. However, in some cases, a further distribution round may be implemented. For example, the blocks distributed to the groups may then be distributed to the physical lanes within the individual groups. For example, the transcoding circuitry 1000 may use a round robin distribution and/or other distribution scheme to accomplish the distribution to the lanes.

For example, 16 virtual lanes, such as PCS lanes, may be encoded on to 16 physical lanes and divided into 4 groups. Thus, in the example, there may be 4 virtual lanes and 4 physical lanes per error correction group. To support the 16 PCS lanes, 20 AM blocks may be grouped together. In some cases, RS-FEC may be applied. The AM blocks may be 64b in length. For an example RS-FEC scheme, a block size of 10b may be used by the transcoder for the group. In some cases, the 20 64b AM blocks may be placed in an integer number of RS symbols.

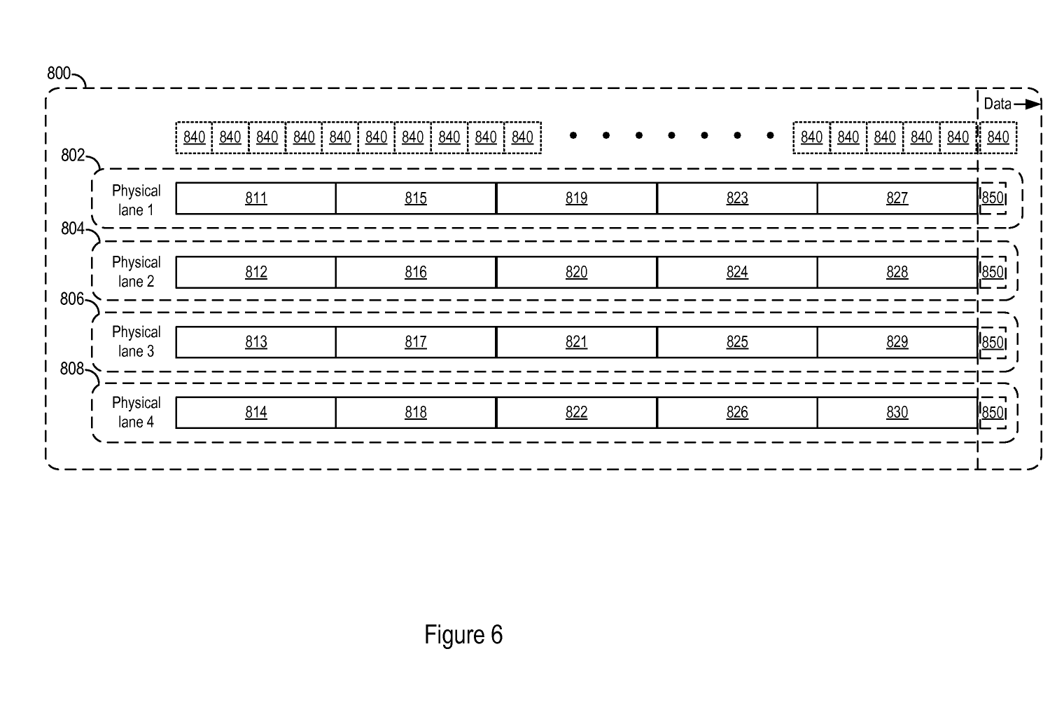

FIG. 6 shows an example distribution 800 of AM blocks for 16 virtual lanes and 16 physical lanes divided into 4 groups. The 4 groups may use the same distribution scheme for the AM blocks. Twenty AM blocks 811-830 may be distributed among the 4 physical lanes 802, 804, 806, 808 in the group 810. The physical lanes uses 10b blocks 840. Because the AM block include an even number of bits and the number of AM blocks, 20, is divisible by 4 and 5, the AM blocks may be distributed over the physical lanes using 10b blocks and a remainder may not necessarily be present. In some cases, one or more bits 850 from the line coding format of the AM blocks may be remaining after distribution of the AM blocks to the physical lanes. These excess coding bits may be transmitted using via data blocks following transmission of the AM blocks. The error correction coding can use a single block code, such as an RS code, Bose-Chaudhuri-Hocquengham (BCH) code, or low-density parity-check (LDPC) code. It can also be an interleaved block coding scheme, wherein multiple block error correction codes are bit-interleaved, symbol-interleaved, multiple-symbol-interleaved, and/or interleaved via another scheme.

In another example, 16 virtual lanes, such as PCS lanes, may be encoded on to 8 physical lanes and divided into 2 groups. Thus, in the example, there may be 8 virtual lanes and 4 physical lanes per error correction group. To support the 16 PCS lanes, 40 AM blocks may be grouped together. In some cases, RS-FEC may be applied. The AM blocks may be 64b in length. For an example RS-FEC scheme, a block size of 10b may be used by the transcoder for the group. In some cases, the 40 64b AM blocks may be placed in an integer number of 10 b RS-FEC blocks.

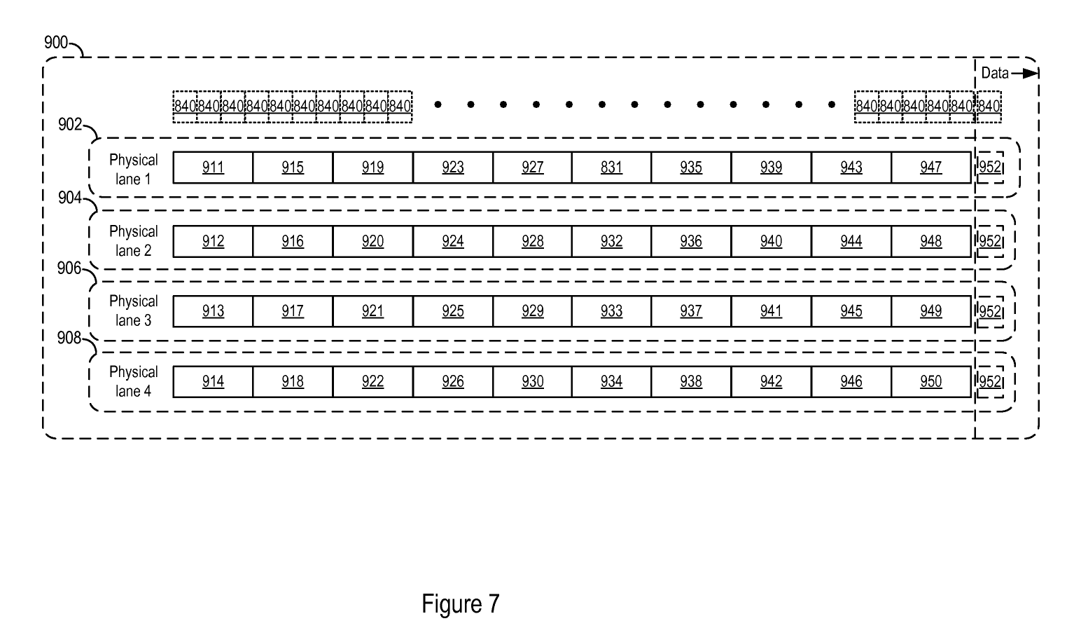

FIG. 7 shows an example distribution 900 of AM blocks for 16 virtual lanes and 8 physical lanes divided into 2 groups. The 2 groups may use the same distribution scheme for the AM blocks. Forty AM blocks 911-950 may be distributed among the 4 physical lanes 902, 904, 906, 908 in the group 910. The physical lanes use 10b blocks 840. Because the number of AM blocks, 40, is divisible by 4 and 10, the AM blocks may be distributed over the physical lanes using 10b blocks and a remainder may not necessarily be present. In some cases, one or more bits 952 from the line coding format of the AM blocks may be remaining after distribution of the AM blocks to the physical lanes. These excess coding bits may be transmitted using via data blocks following transmission of the AM blocks.

In another example, 16 virtual lanes may be encoded on 4 physical lanes in 4 groups. In this case, there may be 1 physical lane per group. In this case, the transcoding circuitry does not necessarily need to distribute the AM blocks to the physical lanes in the group. In some cases, the length of the AM blocks need not necessarily align with the number of error correction blocks. Therefore, the introduction of a fifth AM block to add a multiple of 5 may not be needed. For example 4 AM blocks may be lumped together and transcoded onto the physical lane. Since, the AM blocks are not necessarily being distributed among multiple lanes all of transcoded data may be placed on the destination physical lane for the group. In an example case, the 4×66b AM blocks may be transcoded using 256b/257b transcoding. After being error coded into 10b blocks, the blocks in group may be placed on a single lane. However, in various implementations, 5 AM blocks or other numbers of AM blocks may still be lumped together in cases where the error correction groups include 1 physical lane.

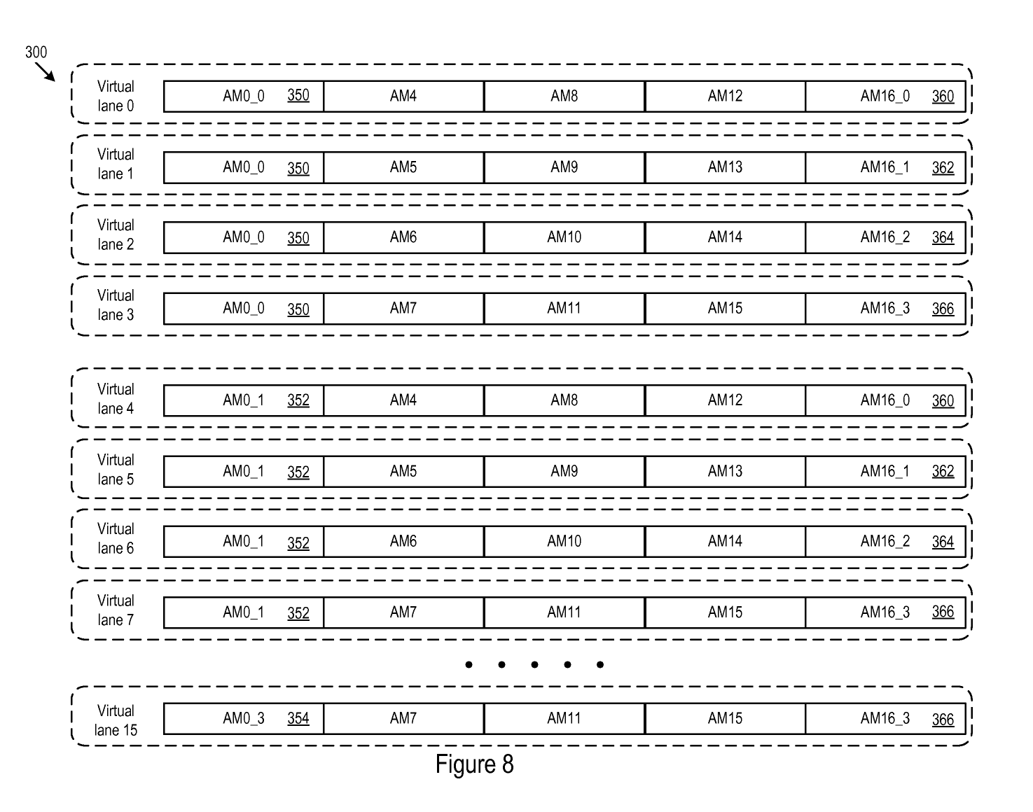

FIG. 8 shows example AM block groups 300 for 400 Gbps data. The data may be sent in 4 grouping of 4 lanes. Four AM block groups of 20 AM blocks may be sent over the 16 PCS lanes. In some implementations, pre-determined AM0 blocks may be sent for the 4 groupings. For example AM0_{—}0 350 AM0_{—}1 352 AM0_{—}2 and AM0_{—}3 354 may be determined variations of AM0. AM16_{—}0 360 AM16_{—}1 362 AM16_{—}2 364 and AM16_{—}3 366 may be determined variations of AM16.

In some implementations, the values for AM0 and AM16 in the IEEE400 system or any other system may be based on values for the 100 Gbps stream. Additionally or alternatively, AM16 can have the same value as AM0. AM4 to AM15 may have determined data patterns. For example, AM4 to AM15 may have the same value as AM0 or AM16. In some cases, AM0=AM4=AM5= . . . =AM15=AM16. In some implementations, an AM0 and an AM16 block may be used in a 2 AM block group. Intervening blocks between the AM0 block and the AM16 block may be forgone.

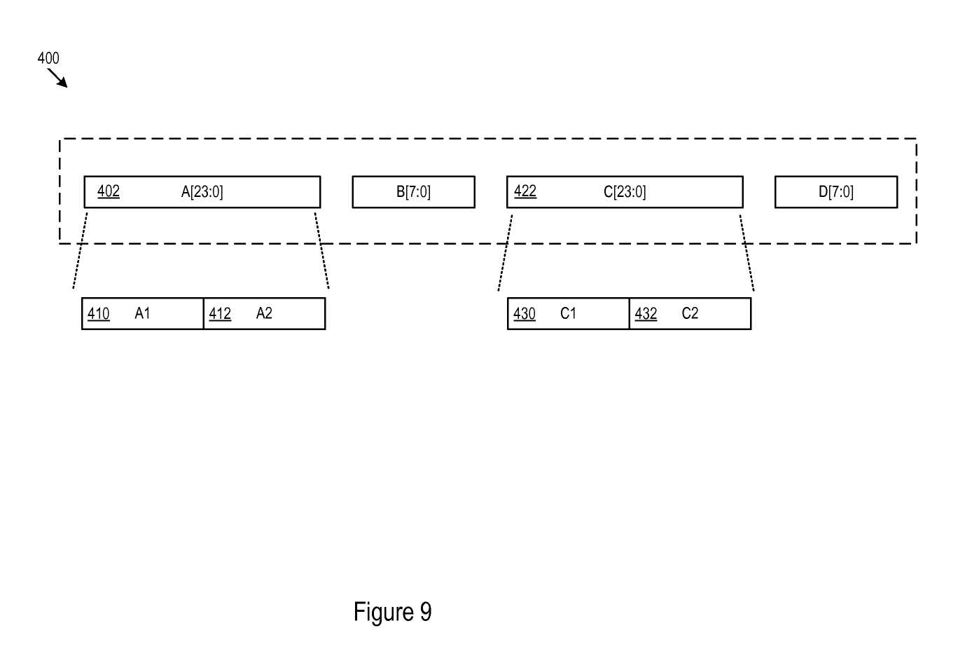

In some implementations, partitions may be created within an AM block. FIG. 9 shows an example partitioned AM block 400. The AM block 400 may be segmented into a 24 bit partition A 402, which includes the M0, M1, and M2 fields of the AM block 400, and a partition C 422, which includes M4, M5, and M6 fields of the data block. The 24 bit A and C partitions may be divided into 12 bit sub-partitions, A1 410 and A2 412, and C1 430 and C2 432, respectively.

Referring again to FIG. 8, for the AM0 block in an AM group the AM0_X variation may be constructed from a base pattern J. J may be a 12 bit sequence, and ˜J may be the bit inverse of the sequence J.

In various implementations, AM0_{—}0 may have partition values J, J, ˜J, ˜J for A1, A2, C1, and C2, respectively. AM0_{—}1 may have partition values J, ˜J, ˜J, J for A1, A2, C1, and C2, respectively. AM0_{—}2 may have partition values ˜J, J, J, ˜J for A1, A2, C1, and C2, respectively. AM0_{—}3 may have partition values ˜J, ˜J, J, J for A1, A2, C1, and C2, respectively. Additionally or alternatively, AM16_{—}0 may have partition values J, J, ˜J, ˜J for A1, A2, C1, and C2, respectively. AM16_{—}1 may have partition values J, ˜J, ˜J, J for A1, A2, C1, and C2, respectively. AM16_{—}2 may have partition values ˜J, J, J, ˜J for A1, A2, C1, and C2, respectively. AM16_{—}3 may have partition values ˜J, ˜J, J, J for A1, A2, C1, and C2, respectively. From these related values the grouping and lane number of a PCS lane may be identified. In these cases, C=˜A.

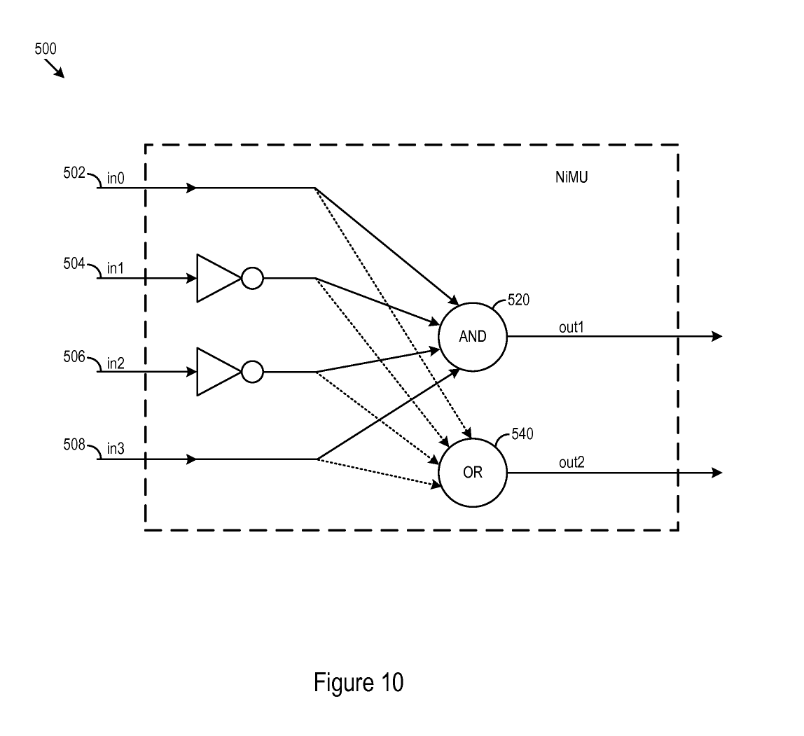

To match incoming bits to the known patterns a nibble matching unit (NiMU) may be used. FIG. 10 shows an example NiMU 500. The example NiMU 500 may identify cases of P and ˜P where P is the 4 bit sequence 1001. For a bit sequence of 1001, in0 502 may receive 1 and output 1, in1 504 may receive 0 and output 1, in2 506 may receive 0 and output 1, in3 508 may receive 1 and output 1. For outputs of 1 the AND 520 may produce an output of 1. Other combinations may result in the AND 520 producing an output of 0. For 0110, in0 502 may receive 0 and output 0, in1 504 may receive 1 and output 0, in2 506 may receive 1 and output 0, in3 508 may receive 0 and output 0. For outputs of 0 the OR 540 may produce an output of 0. Other combinations may result in the OR 540 producing an output of 1. A combination may be identified by an AND 520 output of 1 and the inverse of the combination may be identified be an OR output of 0. For a 12 bit J sequence, a 12 bit matching unit (MU) may be used to identify J or ˜J. The MU may be functionally similar to the NiMU, and may be configured to perform bit analyses of known sequences at various determined bit lengths. For a 48 bit sequence of J and ˜J a 48 bit MU may be used. For a MU of differing bit lengths one AND and one OR may be used.

XOR logic may be implemented to determine an arbitrary sequence match. For known sequence and its bit inverse, XOR logic may be forgone.

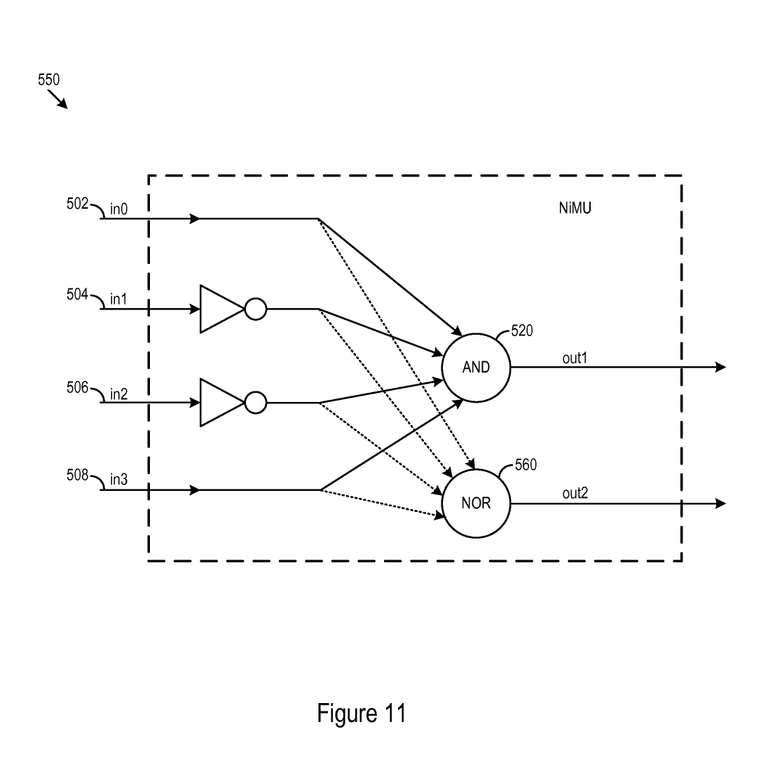

Additionally or alternatively, a NOR may be used in place of the OR logic. FIG. 11 shows an example NiMU 550. In the example NiMU NOR logic 560 is implemented. In some cases, when a bit inverse of the associated sequence is detected the NOR 560 may produce a 1 at its output. The NOR may produce a zero in other cases. For the NiMU 550, the AND may produce a 1 for the associated sequence and a zero for other sequences. For the NiMU, a 1 may be produced by the AND or the NOR if the sequence or the bit inverse is present. Other sequences may produce zero in the AND and the NOR. Additionally or alternatively, a NAND gate may replace the AND gate in a NiMU. A 0 output may be provided if a match to the determined sequence is detected. If the outputs do not indicate a match, the NiMU may report a mismatch for the segment of the data being compared.

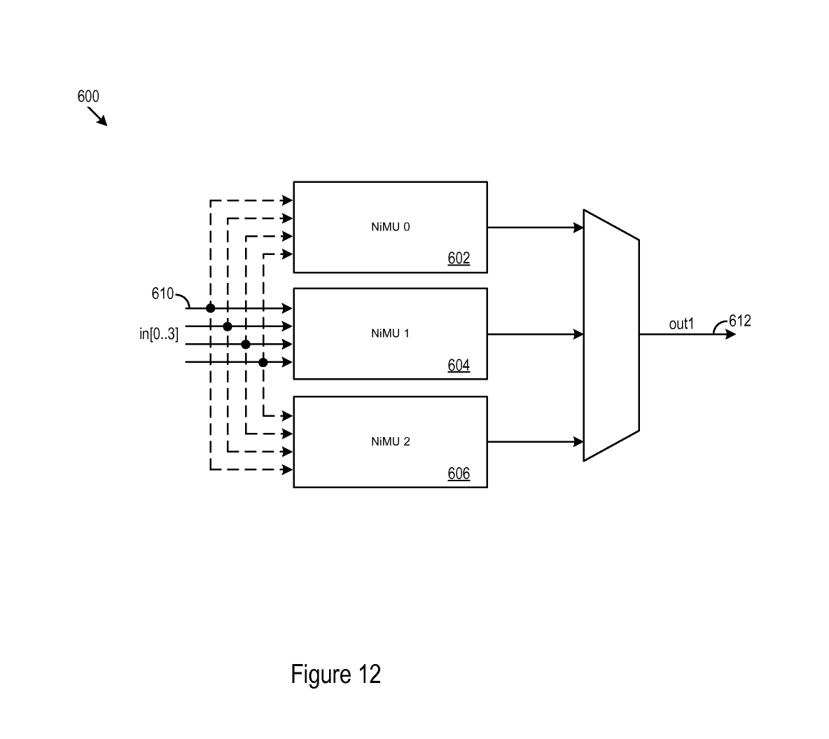

In some implementations, to determine if incoming data matches with one of a number of, e.g., K=3, fixed sequences, parallel NiMUs may be used. FIG. 12 shows an example parallel NiMU system 600. The three parallel NiMUs 602, 604, 606 may produce a 1 at a first output 612 if the input 610 matches at least 1 of the 3 sequences associated with the NiMUs 602, 604, 606. The NiMUs 602, 604, 606 may output a 0 at a second output (not shown) if the input matches at least 1 of the 3 associated inverse patterns.

In some cases, increasing the number of possible patterns may be achieved by increase the number of parallel NiMUs. Increasing the number of parallel NiMUs may be associated with increase system complexity and cost.

To facilitate parallel comparison of incoming data to identify AM blocks. Parallel NiMU units may be used. For example, if data blocks of 66 bits are received in parallel, the system may compare the 66 bits to the known patterns in parallel. Circuitry for handling a comparison of a bit may be copied 66 times to facilitate parallel bit-by-bit searches for AM blocks. For example, a system using 5 NiMUs to identify lanes and groupings may have 330 NiMUs present in its circuitry. A system using 2 NiMUs for identification may have 132 NiMUs present. Bit-by-bit searches of other lengths may be used by the multi-lane system. For example, bit-by-bit searches of 64, 130, 256 or other bit lengths may be implemented.

The system may use an AM block group configuration from the 802.3bj 1000E standard may be used. In this example, 4 different AM0 patterns and 4 different AM16 patterns for 4 different groups of 100 Gbps data streams may be compared. For this example, 12 MUs with different associated sequences per lane may be used to facilitate the identification. The 12 MUs may be repeated to support parallel comparisons. For example, to support a 66 bit-by-bit parallel search the 66 instances of the 12 MUs may be used, which may yield 792 MUs. Increasing the number of MUs used to search among the associated sequences used by a system may increase the number MUs present on circuitry in the system because of the parallel nature of the bit-by-bit search.

For the configurations the J, ˜J sequence variations above, the variations for AM0 sequences may be the same as the variations for AM16 sequences. For a given lane, AM0 may be different from AM16. The sequences from which AM0 and AM16 are selected may be the same. The four variations for AM0 or AM16 sequences may be represented by two sequences and the inverse of those two sequences. Also, C=˜A. For this case, 2 MUs with different associated sequences may be used to facilitate identification. The 2 MUs may be repeated to support parallel comparisons. For example, to support a 66 bit-by-bit parallel search the 66 instances of the 2 MUs may be used, which may yield 132 MUs.

For a system where AM0=AM16 for the lanes, 1 sequence comparison may be performed and 1 MU may be used. The 1 MU may be repeated to support parallel comparisons. For example, to support a 66 bit-by-bit parallel search the 66 instances of the 1 MU may be used, which may yield 66 MUs.

In an EEE mode or non-EEE mode, the lane number may be identified within the AM blocks.

In some cases, a 4x100G-KR4 data may be converted to an IEEE 400 GbE data stream. The 4x100G-KR4 data stream may have 4×20 PCS lanes. The AM group may have 20 blocks per 1000 stream. For the 1000 streams, 65×20 AM block bits may be used in 100G-KR4 data and 5×4×64 AM block bits may be used for IEEE 400 GbE data. To convert the data, a conversion chunk of 65×20×(16384×66)≈1.4 G bits may be used. Additionally or alternatively, 4×16640 66 b blocks may be provided between 4 consecutive AM blocks for the IEEE 400 GbE data. For 4 consecutive AM blocks, 13×20=65×4 so the conversion chunk may be 13 AM block groups, or roughly 13×20×16384×66≈281M bits. In some cases an overclocked 4x100G-KR4 stream may have a different conversion chunk size. For 4×16640 66 bit blocks, 832 FEC blocks may be sent between 2 AM block groups.

Although portions of the disclosure are discussed in terms of 4 groups of 4 lanes, the lane and group identification techniques discussed above may be applied to other configurations. For example, M=24, N=4 (group), K=6 (lanes/group). In this case, the 4 variations of AM0 discussed above may be used. For AM16, the A partition may be broken into 3 sub-partitions and select 6 variations out of 8 possible may be selected.

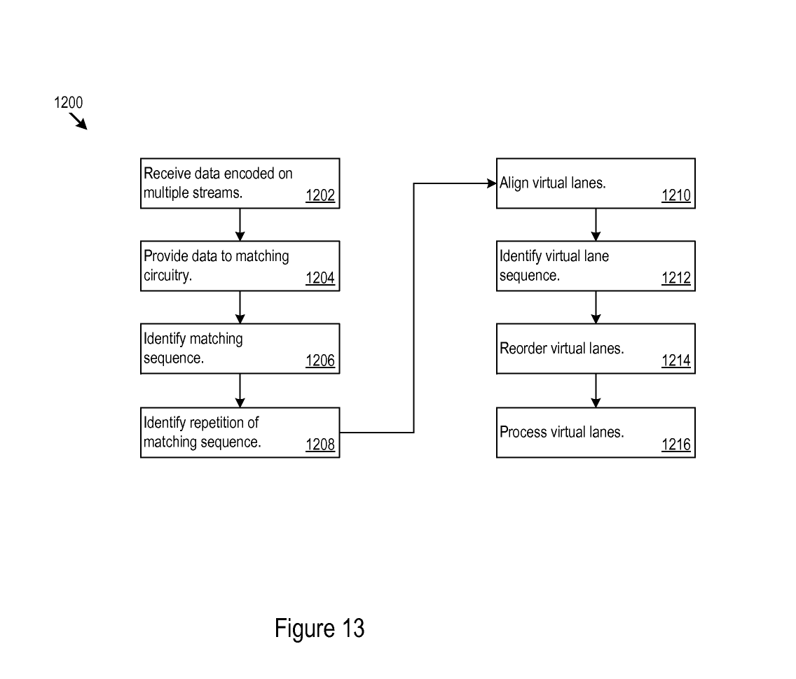

FIG. 13 shows example logic 1200 that alignment circuitry may implement. The alignment circuitry 1200 may receive data encoded on multiple data streams (1202). For example, the data may be encoded on multiple virtual lanes and sent over multiple physical lanes. In some cases, the number of virtual lanes need not necessarily be the same as the number of physical lanes. However, the number of physical lanes may be the same as the number of virtual lanes. The alignment circuitry 1200 may provide a portion of the data to matching circuitry (1204). The matching circuitry may identify a matching sequence or inverse matching sequence within the data (1206). The matching circuitry may identify a repetition of the matching sequence and/inverse matching sequence in a pattern (1208). Based on the pattern, the matching circuitry may align the virtual lanes (1210). For example, the matching circuitry may de-skew or otherwise temporally align the virtual lanes.

The alignment circuitry 1200 may identify the sequence for the virtual lanes. (1212). Based on the identified sequence, the maker circuitry may reorder the virtual lanes (1216). Once aligned and ordered, the system may preform processing tasks on the virtual lanes. For example, the lanes may undergo media access control (MAC) layer processing. Alternatively, the virtual lanes may be passed over another number of physical lanes.

The numerical examples discussed above are presented as a context to explain the principles and architectures for lane identification and grouping and AM block group spacing. Other configurations, e.g., differing numbers of lane groups and/or lanes within groups or differing numbers of data blocks between AM block groups, may be possible.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A device, comprising:
an input configured to receive data in multiple virtual lanes;
an output configured to send the data over multiple physical lanes; and
transcoding circuitry configured to:
group the multiple virtual lanes into individual virtual lane groups with respective individual physical lane groups from the multiple physical lanes;
independently code the individual virtual lanes groups into coding blocks; and
distribute the blocks from the individual virtual lane groups in to the respective individual physical lane groups.

2. The device of claim 1, wherein the coding blocks comprise error correction blocks.

3. The device of claim 2, wherein the transcoding circuitry is configured to code marker blocks from the individual virtual lane groups into the error correction blocks.

4. The device of claim 3, wherein the transcoding circuitry is configured to code a group of the marker blocks from an individual virtual lane group into an integer number of error correction blocks such that the integer number of error correction blocks may be evenly distributed onto a respective individual physical lane group of the individual virtual lane group.

5. The device of claim 1, wherein the transcoding circuitry is configured to code blocks of a first size into blocks of a second size to independently code the individual virtual lanes groups into coding blocks.

6. The device of claim 5, wherein the blocks of the first size comprise marker blocks and the blocks of the second size comprise 256/257-bit-coding blocks.

7. The device of claim 1, wherein an individual virtual lane group and a respective individual physical lane group comprise a single error correction group.

8. The device of claim 1, wherein transcoding circuitry is configured to distribute the coding blocks in a round robin manner.

9. The device of claim 1, wherein the virtual lanes comprise marker blocks, the marker blocks inserted among data blocks in accord with a 16640-block marker spacing.

10. The device of claim 1, wherein an individual virtual lane comprises a marker block, the marker block comprising a series of a pattern and an inverse of the pattern, the series configured to identify the individual virtual lane.

11. A method, comprising:
receiving data in multiple virtual lanes;
grouping the multiple virtual lanes into individual virtual lane groups with respective individual physical lane groups formed from multiple physical lanes;
independently coding the individual virtual lane groups into coding blocks;
distributing the coding blocks from the individual virtual lane groups into the respective individual physical lane groups; and
sending the data over the multiple physical lanes.

12. The method of claim 11, wherein independently coding the individual virtual lane groups into coding blocks comprises coding a group of marker blocks from an individual virtual lane group into an integer number of error correction blocks such that the integer number of error correction blocks may be evenly distributed onto a respective individual physical lane group of the individual virtual lane group.

13. The method of claim 11, wherein an individual virtual lane group and a respective individual physical lane group comprise a single error correction group.

14. The method of claim 11, wherein distributing the coding blocks comprises distributing the coding blocks in a round robin manner.

15. The method of claim 11, wherein the virtual lanes comprise marker blocks, the marker blocks inserted among data blocks in accord with a 16640-block marker spacing.

16. The method of claim 11, wherein an individual virtual lane comprises a marker block, the marker block comprising a series of a pattern and an inverse of the pattern, the series configured to identify the individual virtual lane.

17. A device, comprising:
an input configured to receive data blocks for transmission over multiple virtual lanes and multiple physical lanes;
output circuitry configured to distribute the received data blocks over the multiple physical lanes for transmission; and
marker circuitry configured to:
divide the received data blocks for transmission over the multiple virtual lanes; and
insert marker blocks among the data blocks in an individual one of the multiple virtual lanes based on a marker spacing of 16640 blocks, the marker blocks configured to identify the individual one of the multiple virtual lanes when the individual one of the multiple virtual lanes is distributed on to the multiple physical lanes.

18. The device of claim 17, wherein the marker circuitry is configured to insert marker blocks at an interval corresponding to an integer multiple of the marker spacing.

19. The device of claim 18, wherein:
the marker circuitry is further configure to group together a number of marker blocks in individual one of the multiple virtual lanes; and
the integer multiple is based on the number of marker blocks.

20. The device of claim 19, wherein the number of marker blocks grouped together is based on a size of an error correction block.
